(19) United States
(12) Patent Application Publication
(10) Pub. No.: US 2017/0163068 A1
(43) Pub. Date: Jun. 8, 2017

(54) LEAD-ACID BATTERY SYSTEM, CONTROL SYSTEM AND INTELLIGENT SYSTEM

(71) Applicant: BSB Power Company Ltd, Shenzhen, Guangdong (CN)

(72) Inventors: Bingwen LI, Shenzhen (CN); Yongxin LIU, Shenzhen (CN); Zejun PENG, Shenzhen (CN); Huilong Yang, 518055 (CN); Yalei TIAN, Shenzhen (CN)

(21) Appl. No.: 15/308,834

(22) PCT Filed: Aug. 27, 2015
(86) PCT No.: PCT/CN2015/088228

§ 371 Date: Nov. 3, 2016

(30) Foreign Application Priority Data
Jul. 21, 2015 (CN) 201510431663.3
Jul. 21, 2015 (CN) 201510431664.8

(51) Int. Cl. H02J 7/00; G05B 19/048; H02J 13/00

(52) U.S. Cl. CPC H02J 7/0068; H02J 13/0003; G05B 19/048; G05B 2219/24015

(57) ABSTRACT

The present application discloses a lead-acid system and intelligent system, the lead-acid battery system comprises a measuring and controlling module disposed in the housing of the lead-acid battery, used to collect the status parameters of the lead-acid battery in use; the measuring and controlling module comprises a first communication port; a gateway module, comprising a third communication port, a second communication port and a processor unit, the gateway module collects the status parameters collected by the measuring and controlling module by establishing communication with the first communication port of the measuring and controlling module through the first communication port thereof, to provide for the processor unit to analyze whether the status parameters are abnormal or not; the second communication port of the gateway module is used for remote communication and to send out the collected status parameters. The present application allows users to easily supervise the status of the battery in real time and efficiently manage the lead-acid battery in long-distance in time, thereby efficiently lengthening the service life of lead-acid battery.

### FIELD OF TECHNOLOGY

The present application relates to the field of lead-acid battery management, in particular to a system of internal state parameters management and charge/discharge control.

### BACKGROUND

Valve regulated lead battery is widely used in important places often as a backup power supply, such as electrical room, data room, mobile base station, etc. In recent years, the global market capacity of the valve regulated lead battery has reached a scale of above ten billion RMB one year.

It is necessary to monitor and maintain the valve regulated lead battery in many important places due to its large difference in running environment. Currently, there are two ways of monitoring and maintaining the lead-acid battery in the industry:

The first is manual patrol, the engineering personnel arrives at the site, conducts the current, voltage, temperature and other tests of the lead-acid battery and manually records the test and measure data at intervals (such as 3 months or 6 months). There are some disadvantages in the manual patrol: since many of the base stations are located in remote areas, the personnel and vehicle resource input are large, which is time-consuming and laborious; the personnel entry and exit management is strict because the electricity and room are important places, and there are potential failures in rooms when the personnel enters the room. The second way is setting the monitor system of lead-acid battery, determining the real-time status of the lead-acid battery by collecting the data of current, voltage and the temperature of running environment data of lead-acid battery and taking corresponding countermeasures. The method solves the disadvantage of manual patrol and obtains a certain effect to a certain extent. However, it also brings some new inconveniences: one is that the monitor cable is complicated in connection and easily interferes with the strong electric cable and even causes disconnection and short-circuit; the second is that the environmental temperature cannot truly reflect the usage status of the lead-acid batter and the health status of the lead-acid battery cannot be accurately determined, which leads to being unable to scientifically perform maintenance and preservation.

In the prior art, the backup power supply of the communication base station often shows rapid decrease in capacity after about 2-3 years' using, thereby being forced to be scrapped ahead of time, which causes substantial loss of economy and environmental pollution. Alternatively, the lead-acid battery runs in a low capacity, which shortens the time of backing up power of the base station, thereby influencing the communication service quality of base station and the hidden danger of communication interruption existing.

How to better maintain and lengthen the service life of the valve regulated lead battery is a problem that urgently needs to be solved in the current lead-acid battery industry.

### SUMMARY

According to a first aspect, in one embodiment, a lead-acid battery system is provided, comprising:

a measuring and controlling module, disposed in the housing of the lead-acid battery, used to collect the status parameters of the lead-acid battery in use; the measuring and controlling module comprises a first communication port, used to send out the status parameters collected by the measuring and controlling module; and

a gateway module, comprising a third communication port, a second communication port and a processor unit, the gateway module collects the status parameters collected by the measuring and controlling module by establishing communication with the first communication port of the measuring and controlling module through the third communication port thereof; the second communication port of the gateway module is used for remote communication and to send out the collected status parameters;

wherein the processor unit analyses the status parameters collected from the third communication port of the gateway module and sends out the analytical results through the second communication port.

According to a second aspect, in one embodiment, a lead-acid battery control system is provided, comprising:

a collecting unit and a servo unit, disposed in the housing of the lead-acid battery cell, the collecting unit is used to collect the status parameters of the lead-acid battery cell in use, the status parameters comprise voltage, current and internal temperature of the lead-acid battery cell; the servo unit is used to disconnect and connect the charge and discharge loop of the lead-acid battery cell;

an intelligent gateway, communicating with the collecting unit through the wired communication loop or wireless communication link, acquiring and uploading the status parameters of the lad-acid battery cell collected by the collecting unit at regular time; a raw data collecting unit, used to acquire the raw data of various lead-acid battery cells at the time of shipment from the factory; and a cloud data managing and controlling platform, acquiring and storing the raw data of various lead-acid battery cells at the time of shipment from the factory acquired by the raw data collecting unit; the cloud data managing and controlling platform communicates with the intelligent gateway through the wired or wireless communication link and receives the status parameters of the lead-acid battery cell uploaded by the intelligent gateway; the cloud data managing and controlling platform may drive the intelligent gateway to initiate the check of discharge test on the lead-acid battery cell at regular time, to acquire the discharging curve and calculate the chargeability and health status of the various lead-acid battery cells by the discharging curve of the various lead-acid battery cells, raw data at the time of shipment from the factory and the acquired status parameters in real time, to locate and change the failed lead-acid battery cell.

According to a third aspect, in one embodiment, a lead-acid battery intelligent system is provided, comprising:

the above lead-acid battery system;

a first lead-acid battery, the voltage acquisition unit, the current acquisition unit, the temperature acquisition unit, the servo unit and the first communication port of the lead-acid battery system are disposed in the first lead-acid battery; and

at least one second lead-acid battery, a voltage acquisition unit, a current acquisition unit, a temperature acquisition unit, a servo unit and a first communication port are disposed in the second lead-acid battery; the first lead-acid battery is connected in series to the second lead-acid battery.

Another embodiment provides a lead-acid battery intelligent system, comprising:

the above lead-acid battery control system;

a first lead-acid battery cell, the collecting unit and servo unit of the lead-acid battery control system are disposed in the first lead-acid battery; and

at least one second lead-acid battery cell, the collecting unit of the lead-acid battery control system is disposed in the second lead-acid battery cell; the first lead-acid battery cell is connected in series to the second lead-acid battery cell. According to the above implemented lead-acid battery system and intelligent system, the measuring and controlling module is disposed in the housing of the lead-acid battery, thus the collected temperature of the lead-acid battery in use is the internal temperature of the lead-acid battery, which can more accurately reflect the real-time status and operating condition of the lead-acid battery; the measuring and controlling module is disposed in the housing of the lead-acid battery, which also allows the wiring and winding displacement to be safe and simple when collecting the status parameters of lead-acid battery in use.

According to the above implemented lead-acid battery system and intelligent system, due to the introduction of the raw data storing unit, thus the status parameters of the various lead-acid batteries in use can be compared to the raw data at the time of shipment from the factory, so that the real-time status of the various lead-acid batteries can be more accurately determined, such as, whether the capacity of battery is too low to need changing, etc.

According to the above implemented lead-acid battery system and intelligent system, due to the introduction of gateway module, the third communication port of the gateway module can easily and quickly acquire the status parameters collected by the measuring and controlling module, the second communication port of the gateway remotely sends the acquired status parameters and the analytical results of the status parameter, which allows users to easily supervise the status of the battery in real time and efficiently manage the lead-acid battery in a long-distance in time, thereby efficiently lengthening the service life of lead-acid battery.

According to the above implemented lead-acid battery system and intelligent system, due to the introduction of collecting unit, thus the status parameters of the lead-acid battery cell in use can be detected in real time and the detected status parameters can be sent out.

According to the above implemented lead-acid battery system and intelligent system, due to the introduction of raw data collecting unit, thus the raw data of the various lead-acid cells at the time of shipment from the factory can be acquired.

According to the above implemented lead-acid battery system and intelligent system, due to the introduction of collecting unit and the raw data collecting unit, thus the status parameters of the various lead-acid battery cells in use and the raw data at the time of shipment from the factory can be acquired, so that the life cycle of various lead-acid battery cells from producing to using can be traced and detected, the solid data can be provided for the management and maintenance of the various lead-acid battery cells, which can allow users better manage and maintain the lead-acid battery and efficiently lengthen the service life of the lead-acid battery.

According to the above implemented lead-acid battery system and intelligent system, due to the introduction of collecting unit and intelligent gateway, the users can detect the status parameters of the lead-acid battery through the cloud data managing and controlling platform in real time and perform the maintenance for the lead-acid battery cell. When the acquired parameters is abnormal, the command of disconnecting the charging loop of the lead-acid battery cell is sent to the collecting unit, to avoid long-term overcharging and high-temperature inappropriate charging of the lead-acid battery cell, which efficiently lengthens the service life of the lead-acid battery.

### BRIEF DESCRIPTION OF THE DRAWINGS

FIG. 1 is a structure diagram of lead-acid battery system in one embodiment of the application;

FIG. 2 is another structure diagram of lead-acid battery system in one embodiment of the application;

FIG. 3 is a structure diagram of lead-acid battery system comprising a plurality of gateway modules and lead-acid batteries in one embodiment of the application;

FIG. 4 is a partial structure diagram of lead-acid battery intelligent system in one embodiment of the application;

FIG. 5 is a structure diagram of lead-acid battery control system in one embodiment of the application;

FIG. 6 is a structure diagram of lead-acid battery intelligent system in one embodiment of the application.

### DESCRIPTION OF THE EMBODIMENTS

The present application will be further explained in detail in combination with the drawings and specific implementation below.

### Embodiment 1

Please refer to FIG. 1, the present application provides a lead-acid battery system, comprising a measuring and controlling module 10 and a gateway module 20, and in a preferred embodiment, further comprising a user terminal 30. It will be specifically described.

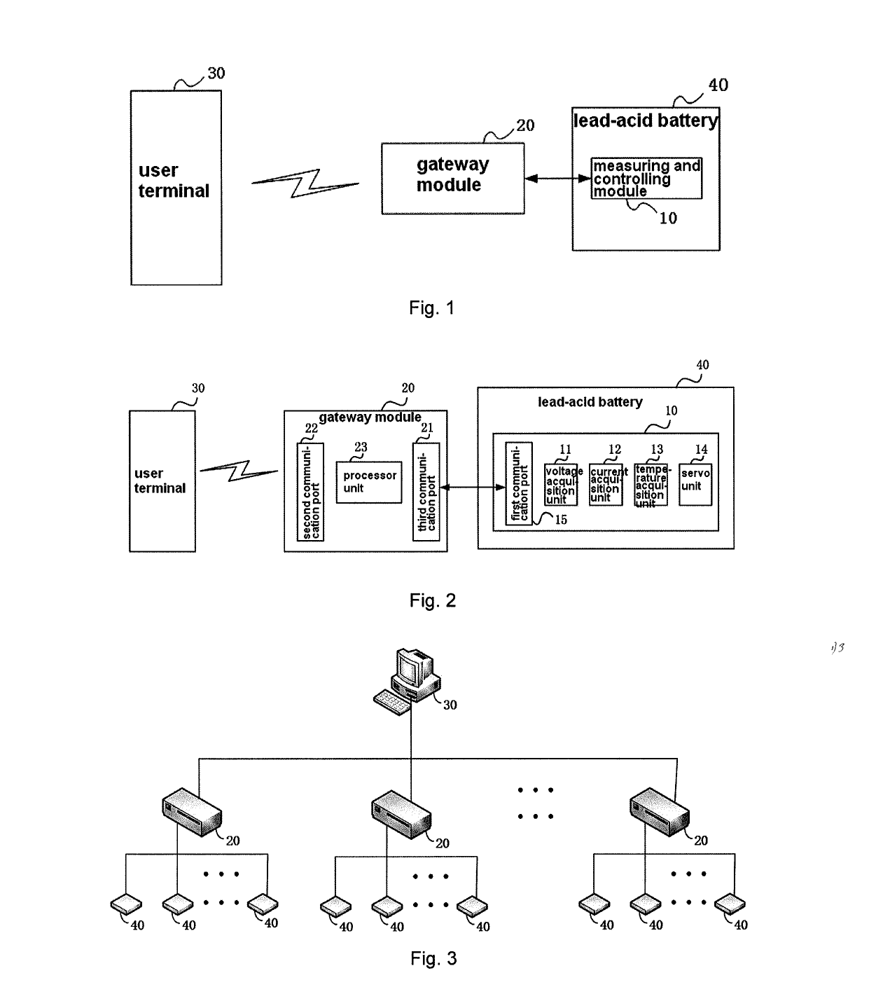

The measuring and controlling module 10 is disposed in the housing of the lead-acid battery 40, used to collect the status parameters of the lead-acid battery 40 in use and the status parameters comprises current, voltage, internal temperature, etc. In a detailed embodiment, as shown in FIG. 2, the measuring and controlling module 10 comprises a voltage acquisition unit 11, a current acquisition unit 12 and a temperature acquisition unit 13 respectively used to collect the voltage, current and internal temperature of the lead-acid battery 40. Due to the measuring and controlling module 10 disposed in the lead-acid battery 40, the temperature collected by the temperature acquisition unit 13 is the internal temperature of the lead-acid battery 40 rather than the environmental temperature and the internal temperature of the lead-acid battery 40 can better reflect the real-time status of the lead-acid battery 40.

The measuring and controlling module 10 further comprises the first communication port 15 used to send out the collected status parameters of the lead-acid battery 40. In the embodiment, the first communication port is RS485 interface, due to the measuring and controlling module 10 disposed in the lead-acid battery 40 and the introduction of the first communication port 15, thus the winding displacement and wiring of the lead-acid battery of the present application is simple and convenient, the safety accidents such as disconnection and short circuit do not easily occur and the strong interference to the power supply of the lead-acid battery 40 may not be caused.

In a preferred embodiment, the measuring and controlling module 10 can respond to the control command sent by the gateway module 20 through the third communication port 21 of the gateway module 20, to connect or disconnect the charge and discharge loop of the lead-acid battery. In a detailed embodiment, the measuring and controlling module 10 further comprises the servo unit 14. When the measuring and controlling module 10 receives the command of connecting/disconnecting the charge and discharge loop of the lead-acid battery sent by the gateway module 20, the measuring and controlling module 10 controls the servo unit 14 to connect/disconnect the charge and discharge loop of the lead-acid battery. When AC is disconnected, the servo unit 14 instantly connects the discharge loop of the lead-acid battery to supply power.

The gateway module 20 comprises the third communication port 21, the second communication port 22 and the processor unit 23.

The gateway module 20 establishes communication with the first communication port 15 of the measuring and controlling module 10 though the third communication port 21 thereof, thus the gateway module 20 collects the status parameters of the lead-acid battery 40 collected by the measuring and controlling module 10. In the embodiment, the third communication port 21 of the gateway module 30 is also RS485 interface. Due to the fact that in most cases a plurality of lead-acid batteries 40 are used together as backup power supply to supply power, thus the gateway module 20 can establish communication with the measuring and controlling module 10 disposed in the various lead-acid batteries 40 in the backup power supply through the RS485 bus, to send the real-time status parameters of the lead-acid battery 40 to the user terminal 30.

The processor unit 23 is used to analyze the status parameters acquired through the third communication port 21. In a detailed embodiment, the processor unit 23 analyzes whether the status parameters are abnormal or not, such as, by comparing the acquired status parameters in real time and preset status parameters threshold, when determining the status parameters are abnormal, the processor unit 23 sends the command of disconnecting the charge loop of the lead-acid battery to the measuring and controlling module 10 through the third communication port 21 and sends the warming to the user terminal 30 through the second communication port 22, to remind the users to deal with the abnormal situation of the lead-acid battery 40, such as whether changing the lead-acid battery. To sum up, the status parameters of the lead-acid battery 40 comprise current, voltage, internal temperature, etc., thus the status parameters threshold preset in the processor unit 23 comprise current threshold, voltage threshold and temperature threshold. When the acquired current/voltage of the lead-acid battery 40 in real time reach the current/voltage threshold or the temperature reaches the temperature threshold, the status parameters are determined to be abnormal, the servo unit 14 is controlled to disconnect the charge loop of the lead-acid battery, to allow the lead-acid battery 40 to avoid the long-term overcharge, high-temperature charge, etc., and an appropriate temperature is selected to charge the lead-acid battery 40, which efficiently lengthens the service life of the lead-acid battery 40 from the traditional 2-3 years to at least 6-9 years. In a preferred embodiment, the processor unit 23 is provided with the charge period and charge time parameters. The command of connecting the charge loop of the lead-acid battery is sent to the measuring and controlling module 10 within the set charge period and charge time, while the command of disconnecting the charge loop of the lead-acid battery is sent to the measuring and controlling module outside of the set charge period and charge time. The users can send the commands to the gateway module 20 through the user terminal 30, to set the above status parameters threshold, charge period and charge time parameters. In the embodiment, the processor unit 23 comprises ARM9 processor.

The second communication port 22 of the gateway module 20 is used for remote communication and to send out the status parameters of the lead-acid battery 40, the analytical results and abnormal warning of the processor unit 23 and so on transmitted by the measuring and controlling module 10. In the embodiment, the gateway module 20 establishes communication with the user terminal 30 through the second communication port 22. The second communication port 22 comprises WIFI interface and GPRS interface, WIFI interface provides a function of very stable remote communication and GPRS interface provides a function of very instant remote communication. Of course, the second communication port 22 further comprises 3G interface and/or 4G interface. The introducing of the second communication port 22 allows the users to use the user terminal 30 to control the charge and discharge of the lead-acid battery 40 by the gateway module 20 and to manage the data such as the status parameters of the lead-acid battery 40, which solves the problem of inability to supervise the status of the lead-acid battery in real time and achieves the function of instantly and efficiently managing and monitoring the lead-acid battery in a long-distance.

The introduction of the gateway module 20 allows the user terminal 30 to detect the status parameters of the lead-acid battery 40 in time, which provides the reliable data support for calculating the SOC, SOH of the lead-acid battery 40 and the left service life of the lead-acid battery 40. SOC (State of Charge) refers to the chargeability of the battery. The SOC of fully charged battery is 100%, with the discharging of the battery in use, the quantity of electric charge of the battery finally decreases to 0, at this time, SOC is 0%, so the SOC reflects the state of quantity of electric charge of the battery; SOH (State of Health) refers to the state of health of the battery, SOH=current maximum capacity of the battery/nominal capacity of the battery*100%, SOH reflects the current capacity of the battery with the percent. SOH of a new battery is larger than or equal to 100%, SOH gradually decreases as the battery ages. It is specified in the IEEE Standard1188-1996 that when the capacity of the battery decreases to 80% or below, i.e. SOH≦80%, the battery should be changed. When the lead-acid battery 40 as the backup power supply, acquiring the SOHs of the various lead-acid batteries 40 in the backup power supply at any time has a great effect on securing the working liability of backup power system. When AC is disconnected and the lead-acid battery 40 discharges to supply power, acquiring the SOCs of the various lead-acid batteries 40 in the back power supply at any time has a great effect on mastering how long the backup power supply can supply power for the users. By acquiring how long the power supply can supply power, the users can take the corresponding actions ahead of time.

The user terminal 30 receives and stores the status parameters of the lead-acid battery 40 collected by the measuring and controlling module 10 by the gateway module 20 and receives the analytical results of the processor unit 23 of the measuring and controlling module 20. The user terminal 30 also can control the servo unit 14 to connect and disconnect the charge and discharge loop of the lead-acid battery by the gateway module 20, and is used to send commands of setting status parameters threshold, charge period and charge time parameters to the processor unit 23, to manage the lead-acid battery 40 and to make the lead-acid battery 40 operate in the optimum situation. In a detailed embodiment, the user terminal 30 may be a computer.

As shown in FIG. 3, in practical cases, a plurality of lead-acid batteries 40 are often used together as backup power supply to supply power for the electrical room, data room, mobile base station, etc. when the AC is disconnected, thus taking this into consideration, the user terminal 30 of the present application may establish communicative connection with one or more gateway module 20, while the gateway module 20 may establish communicative connection with one or more lead-acid batteries 40.

In order to more accurately determine the real-time status of the various lead-acid batteries, the present application further comprises the raw data storing unit. The raw data storing unit is stored with the raw data of the various lead-acid batteries at the time of shipment from the factory. The raw data comprises the capacity, charge and discharge characteristic curve, internal resistance, grouping information and identifying number and so on of the various lead-acid batteries at the time of shipment from the factory. And the raw data storing unit is disposed in the housing of the lead-acid battery 40, the gateway module 20 or the use terminal 30. The present application introduces the raw data storing unit, thus the status parameters of the various lead-acid batteries 40 in use can be compared to the raw data at the time of shipment from the factory, so that the real-time status of the various lead-acid batteries 40 can be more accurately determined, such as, whether the capacity of battery is too low to need changing, etc.

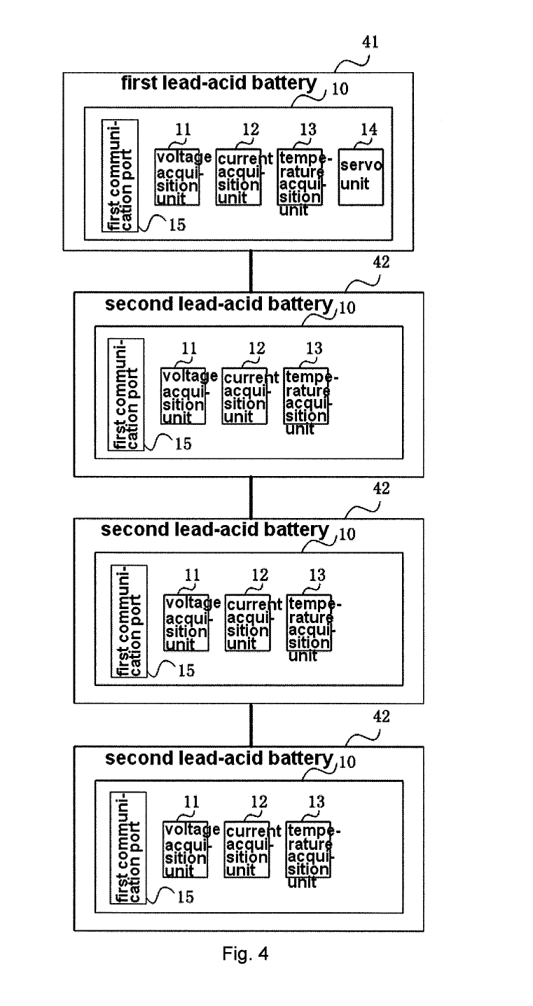

The present application further discloses a lead-acid battery intelligent system, comprising the above lead-acid battery system and lead-acid battery 40. In order to save the devices, as shown in FIG. 4, the lead-acid battery intelligent system of the present application comprises the above lead-acid battery system, the first lead-acid battery 41 and at least one second lead-acid battery 42. The voltage acquisition unit 11, current acquisition unit 12, temperature acquisition unit 13, servo unit 14 and first communication port 15 are disposed in the first lead-acid battery 40; the voltage acquisition unit 11, current acquisition unit 12, temperature acquisition unit 13, servo unit 14 and first communication port 15 are disposed in the second lead-acid battery 42. The first lead-acid battery 41 is connected in series to the second lead-acid battery 42, thus the servo unit 14 in the first lead-acid battery can connect and disconnect the charge and discharge loop after the first lead-acid battery 41 is connected in series to the second lead-acid battery 42.

In the present application, the users can acquire the real-time status at parameters of the lead-acid battery 40 at any time by the gateway module 20 on the user terminal 30, to provide accurate data bases for the maintaining and preserving the lead-acid battery 40, calculating SOC and SOH and estimating the service life. During the running process of the lead-acid battery 40, when the gateway module determines the real-time status parameters of the lead-acid battery 40 to be abnormal, the servo unit 14 is controlled to disconnect the charge loop of the lead-acid battery 40 and send the warning to the user terminal to remind the users to deal with in time, thus which avoids long-term overcharging and high-temperature inappropriate charging of the lead-acid battery 40, efficiently lengthens the service life of the lead-acid battery and decreases the amount of scrapped lead-acid battery every year and the environmental pollution caused by this. The users also can set status parameters threshold, charge period and charge time parameters and so on through the user terminal 30 to the gateway module 20, to make the lead-acid battery 40 operate in the optimum situation. The present application achieves the function of remote monitoring and managing the lead-acid battery.

### Embodiment 2

The lead-acid battery supplies power for switching power supply off or uninterruptible power supply often as the backup power supply after the AC is disconnected, while in the case of AC being normal, the switching power supply off or the uninterruptible power supply, etc. introduces the electric energy of the AC to charge the lead-acid battery. In practical use, a plurality of lead-acid battery packs are often used together as the backup power supply and the lead-acid battery pack comprises some lead-acid battery cells.

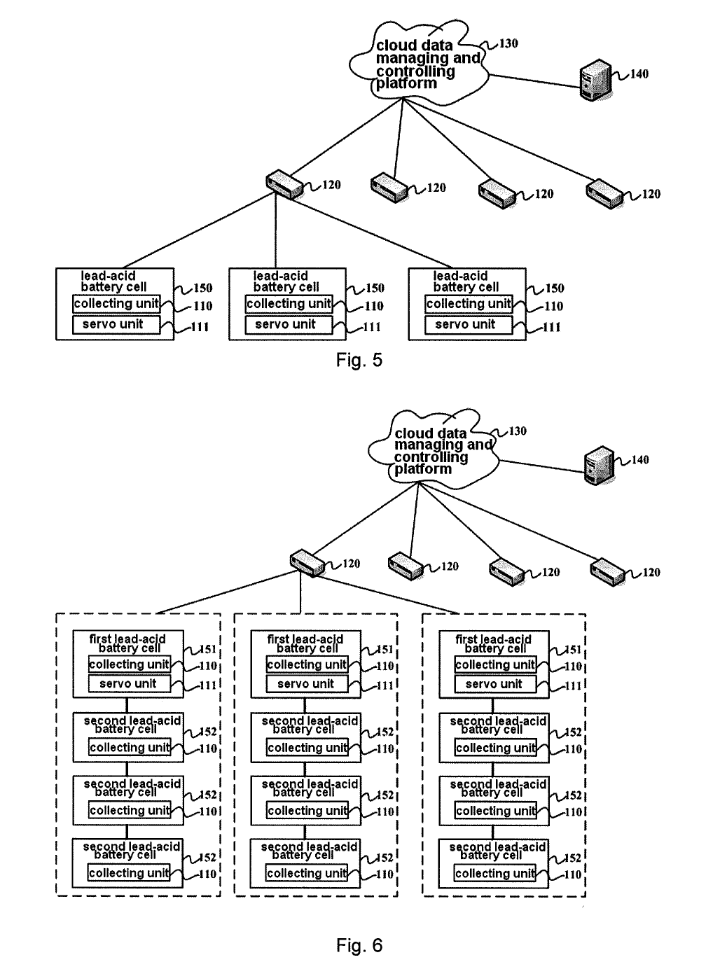

Please refer to FIG. 5, the embodiment provides a lead-acid battery control system, used to monitor and manage the various lead-acid battery cells 150, comprising the collecting unit 110, servo unit 111, intelligent gateway 120, cloud data managing and controlling platform 130 and raw data collecting unit 140. It will be specifically described.

The collecting unit 110 and the servo unit 111 are disposed in the housing of the lead-acid battery cell 150, wherein, the collecting unit 110 is used to collect the status parameters of the lead-acid battery cell 150 in use, the status parameters comprise the voltage, current and internal temperature of the lead-acid battery cell 150; and the servo unit 111 is used to disconnect and connect the charge and discharge loop of the lead-acid battery cell 150. The collecting unit 110 is electrically connected to the servo unit 111, the collecting unit 110 is also used to respond to the control command of the intelligent gateway 120 to allow the servo unit 111 to connect or disconnect the charge and discharge loop of the lead-acid battery cell 150. It should be noted that although the collecting unit 110 and the servo unit 111 are powered to operate by the lead-acid battery cell 150, the collecting unit 10 and the servo unit 111 have an excellent performance of ultra-low power consumption, and at the stage of producing, storing and on-line running of the lead-acid battery cell 150, the collecting unit 110 and the servo unit 111 sleeps or operates according to the stage the lead-acid battery cell 150 is in, thus compared to the self-discharge power consumption of the lead-acid battery cell 150, the power consumption of the collecting unit 110 and the servo unit 111 is very small and the influence on the performance of the lead-acid battery cell 150 can be negligible.

The intelligent gateway 120 communicates with the collecting unit 110 through the wired communication loop or the wireless communication link. When the intelligent gateway 120 communicates with the collecting unit 110 through the wired communication loop, if it fails at some point of the communication loop, the communication loop will be disconnected into two communication links, which still can guarantee the normal communication between the intelligent gateway 120 and the collection unit 110 with the communication loop failure occurring. In the embodiment, the wired communication loop is achieved through the RS485 interface; when the intelligent gateway 120 communicates with the collecting unit 110 through the wireless communication link, there is no traditionally complicated wiring in the intelligent gateway 120, the collecting unit 110 and the servo unit 111, thus the safety accidents such as disconnection and short circuit do not occur caused by the complicated wiring. The intelligent gateway 120 acquires the status parameters of the lead-acid battery cell 150 collected by the collecting unit 110 at regular time. In a detailed embodiment, the intelligent gateway 120 acquires the status parameters of the various servo units 110 by applying the way of master-slave communication every 3 seconds. When the number of the collecting and servo unit 110 hanged under the intelligent gateway 120 is too large, it sometimes cannot be guaranteed that the intelligent gateway 120 can communicate with the each collecting and servo unit 110 every 3 seconds. In a preferred embodiment, the above problem can be solved by sending the time synchronizing command to the collecting unit 110 through the intelligent gateway 120 at regular time, specifically, the intelligent gateway 120 broadcasts the time synchronizing command to the collecting unit 110 in communicative connection therewith and the synchronous counter thereof is cleared after the various collecting units 110 receive the time synchronizing command. The collecting unit 110 collects the status parameters of the lead-acid battery cell 150 every 3 seconds, which are stored in the memory of the collecting unit 110 together with the counting of the synchronous counter. Every the collecting unit 110 collects the status parameters, the synchronous counter increases by 1. After the collected status parameters uploaded by collecting unit 110 requested by the intelligent gateway 120 are received, the status parameters in the memory and the corresponding counting of the synchronous counter are packaged to upload to the intelligent gateway 120. The memory is cleared after it is determined that the intelligent gateway 120 receives the packaged data. And after the intelligent gateway 120 receives the packaged data uploaded by the collecting unit 110, the synchronization of the status parameters is achieved automatically, according to the counting of the synchronous counter in the data package. When determining the acquired status parameters are abnormal, the intelligent gateway 120 sends the command of disconnecting the charge loop of the lead-acid battery cell 150 with abnormal status parameters to the collecting unit 110, so that the servo unit 111 disconnects the charge loop of the lead-acid battery cell 150. At the same time, the intelligent gateway 120 also sends the warning of the abnormal status parameters to the cloud managing and controlling platform 130 to be dealt with by the users in time, so that long-term overcharging and high-temperature inappropriate charging of the lead-acid battery cell 150 are avoided, which efficiently lengthens the service life of the lead-acid battery cell 150. The abnormal status parameters comprise the voltage reaching to the set voltage threshold, the current reaching to the set current threshold and the internal temperature reaching to the set temperature threshold. And the users can set the operation parameters in the intelligent gateway 120 by the cloud data managing and controlling platform 130 and the operation parameters comprise the voltage threshold, current threshold and the temperature threshold, etc.

The intelligent gateway 120 can also communicates with the power supply via serial port or the network port and the power supply is the switching power supply off or the uninterruptible power supply; the intelligent 120 analyzes whether the charging parameters of the lead-acid battery cell 150 by the power supply is reasonable or not according to the environmental temperature, status parameters and the raw data of the lead-acid battery cell 150 at the shipment from the factory and performs the real-time adjustment. The charging parameters comprise equalized float charge voltage and the charge period, and the intelligent 120 uploads the operation parameters of the power supply to the cloud data managing and controlling platform 130. The environmental temperature of the above lead-acid battery cell 150 can be collected by the intelligent gateway 120, and the raw data of the lead-acid battery cell 150 at the time of the shipment from the factory can be provided by the raw data collecting unit 140.

The intelligent 120 uploads the status parameters of the lead-acid battery cell 150 and the operation parameters of the power supply to the cloud data managing and controlling platform 130 to statistically analyze and stores the parameters of the power supply and the status parameters acquired from the various collecting units 110 when the communication is interrupted with the cloud data managing and controlling platform 130 and automatically uploads again to the cloud data managing and controlling platform 130 after the communication is restored. In the embodiment, the intelligent gateway 120 communicates with the cloud data managing and controlling platform 130 through the 2G/3G/4G communication network provided by the communication carriers. There are a maximum of 128 collecting servo unit 110 hanged under the intelligent gateway 120, which can store the data for 7 days.

The raw data collecting unit 140 acquires the raw data of the lead-acid battery cell 150 at the time of shipment from the factory; the raw data comprise the identifying number, capacity, internal resistance, charge and discharge characteristic curve and grouping information, etc. Due to the raw data especially the capacity, internal resistance and charge and discharge characteristic curve of the lead-acid battery cell 150 at the time of shipment from the factory are more similar, the operation performance of the lead-acid battery pack constituted thereof by grouping is more better and the service life thereof is more longer, thus in a preferred embodiment, the raw data collecting unit 140 groups the various lead-acid battery cells according to the acquired raw data of the various lead-acid battery cells 150 at the time of the shipment from the factory.

The cloud data managing and controlling platform 130 acquires and stores the raw data of the various lead-acid battery cells 150 at the time of shipment from the factory acquired by the raw data collecting unit 140. The cloud data managing and controlling platform 130 further automatically introduces the data uploaded by the intelligent gateway 120 into the corresponding cloud data managing and controlling platform 130 according to the configuration information of the intelligent gateway 120 and the identifying number and the grouping information of the lead-acid battery cell 150 of the raw data of the raw data collecting unit 140.

The cloud data managing and controlling platform 130 communicates with the intelligent gateway 120 through the wired or wireless communication link and receives the status parameters of the lead-acid battery cell and the operation parameters of the power supply uploaded by the intelligent gateway 120. The cloud data managing and controlling platform 130 may drive the intelligent gateway 120 to initiate the check of the discharge test of the lead-acid battery cell at regular time to acquire the discharging curve and calculates the chargeability and health status of the various lead-acid battery cells by the discharging curve, raw data at the time of shipment from the factory and the acquired status parameters in real time of the various lead-acid battery cells to locate and change the failed lead-acid battery cell, which is very convenient.

The chargeability of the battery (State of Charge) refers to SOC. The SOC of fully charged battery is 100%, with the discharging of the battery in use, the quantity of electric charge of the battery finally decreases to 0, at this time, SOC is 0%, so the SOC reflects the state of quantity of electric charge of the battery; the state of health of the battery (State of Health) refers to SOH, SOH=current maximum capacity of the battery/ nominal capacity of the battery*100%, SOH reflects the current capacity of the battery with the percent. SOH of a new battery is larger than or equal to 100%, SOH gradually decreases as the battery ages. It is specified in the IEEE Standard1188-1996 that when the capacity of the battery decreases to 80% or below, i.e. SOH<80%, the battery should be changed. When the lead-acid battery cell 150 as the backup power supply, acquiring the SOHs of the various lead-acid battery cells 150 in the back power supply at any time has a great effect on securing the working liability of backup power system. When AC is disconnected and the lead-acid battery cell 150 discharges to supply power, acquiring the SOCs of the various lead-acid battery cells 150 in the back power supply at any time has a great effect on mastering how long the backup power supply can supply power for the users. By acquiring how long the power supply can supply power, the users can take the corresponding actions ahead of time. In addition, the present application introduces the raw data collecting unit 140, thus the status parameters of the various lead-acid battery cells 150 in use can be compared to the raw data thereof at the time of shipment from the factory, so that the real-time status of the various lead-acid battery cells 150 can be more accurately determined, such as, whether the SOH is too low to need changing, etc.

The cloud data managing and controlling platform 130 further provides the monthly report of the operation of the various lead-acid battery cells 150 and makes the electronic report of SOC and SOH according to the status parameters, discharge curve and the raw data of the various lead-acid battery cells 150 at the time of shipment from the factory.

The cloud data managing and controlling platform 130 stores the status parameters, discharge curve, chargeability and health status of the various lead-acid battery cells. The cloud data managing and controlling platform 130 provides total life assets management for the lead-acid battery cell 150, i.e. storing and invoking the operation status parameters of the various lead-acid battery cells 150 and the raw data at the time of shipment from the factory, storing and invoking the data of full life cycle of various lead-acid battery cells 150 from producing to using. These data have a great effect on managing, maintaining the lead-acid battery cell 150 and analyzing the service life thereof by the expert to allow the users to perform preventative maintaining, changing and repairing for the lead-acid battery cell 150. These data also provide solid data support for the basic development of the lead-acid battery, such as, the cloud data managing and controlling platform 130 uses the acquired internal temperature, voltage, current, capacity, depth of charge and discharge, number of charge and discharge, etc. of the lead-acid battery cell 150 to contrastively analyze the relationship between the manufacturing technology and the application environment of the lead-acid battery and to provide data support for the subsequent improvement of the manufacturing technology, the charge and discharge parameters and the capacity of the lead-acid battery.

The foregoing has been shown to illustrate the principle and structure of the lead-acid battery system provided by the application. It should be intentionally noted that the number of the lead-acid battery cell 150, intelligent gateway 120, cloud data managing and controlling platform 130 and raw data collecting unit 140 in FIG. 5 is only used to illustrate and do not indicate the actual number. And the users can connect a plurality of lead-acid battery cells 150 including the collecting unit 110 and the servo unit 111 therein with the intelligent gateway 120 and connect the intelligent gateways 120 with the cloud data managing and controlling platform 130, etc.

The present application further discloses a lead-acid battery intelligent system, comprising the above lead-acid battery system and the lead-acid battery cell 150, wherein the collecting unit 110 and the servo unit 111 are disposed in each lead-acid battery cell 150. In order to save the devices, in a preferred embodiment, as shown in FIG. 6, the lead-acid battery intelligent system comprises the above lead-acid battery control system, the first lead-acid battery cell 151 and at least one second lead-acid battery cell 152. The collecting unit 110 and the servo unit 111 are disposed in first lead-acid battery cell 151, while the collecting unit 110 is disposed in the second lead-acid battery cell 152. The first lead-acid battery cell 151 is connected in series to the second lead-acid battery cell 152, thus the servo unit 111 in the first lead-acid battery can connect and disconnect the charge and discharge loop after the first lead-acid battery cell 151 is connected in series to the second lead-acid battery cell 152.

The lead-acid battery control system and intelligent system provided by the present application can trace and detect the full life cycle parameters of the lead-acid battery cell 150 from producing to using, compare the raw data of lead-acid battery cell 150 at the time of shipment from the factory to the status parameters in use, make accurate judgment for the maintenance and preservation of the lead-acid battery cell 150 and provide enough data bases for calculating SOC and SOH of the lead-acid battery cell 150, while the traditional lead-acid battery monitoring system cannot acquire the raw data of the lead-acid battery cell 150 at the time of shipment from the factory, thus the judgment for the maintenance and preservation thereof and the calculated SOC and SOH are very inaccurate. The lead-acid battery control system provided by the present application sends the warning information to the cloud data managing and controlling platform 130 in time to prompt users to deal with in time when the status parameters of the lead-acid cell 150 are abnormal, which realizes the remote, real-time control and management of the lead-acid battery cell 150 and the users can set the operation parameters to the intelligent gateway 120 through the cloud data managing and controlling platform 130 to make the lead-acid battery cell 150 operate in the optimum situation. The present application significantly increases the service life of the lead-acid battery by the above technical means, which not only has a direct economic benefit, but also decreases the amount of scrapped lead-acid battery ahead of time every year and the environmental pollution caused by this.

The foregoing uses particular examples to explain the present invention and is only to help in understanding the present invention and is not limiting of the present invention. Modifications can be made to the above specific implementations by those skilled in the art according to the concept of the present invention.

What is claimed is:

1. A lead-acid battery control system, comprising:
a measuring and controlling module, disposed in the housing of the lead-acid battery, used to collect the status parameters of the lead-acid battery in use;
the measuring and controlling module comprises a first communication port, used to send out the status parameters collected by the measuring and controlling module; and
a gateway module, comprising a third communication port, a second communication port and a processor unit, the gateway module collects the status parameters collected by the measuring and controlling module by establishing communication with the first communication port of the measuring and controlling module through the third communication port thereof; the second communication port of the gateway module is used for remote communication and to send out the collected status parameters.
wherein the processor unit analyses the status parameters collected from the third communication port of the gateway module and send out the analytical results through the second communication port.

2. The lead-acid battery system of claim 1, wherein the measuring and controlling module is also used to respond to the control command sent by the processor unit through the third communication port, to connect or disconnect the charge and discharge loop of the lead-acid battery.

3. The lead-acid battery system of claim 2, when analyzing the collected status parameters abnormal, the processor unit sends the command of disconnecting the charge loop of the lead-acid battery to the measuring and controlling module through the third communication port, and sends the warming to the users through the second communication port.

4. The lead-acid battery system of claim 3, wherein the processor unit is provided with the status parameters threshold, the processor unit compares the collected status parameters to the status parameters threshold to determine whether the status parameters are abnormal or not; the processor is also provided with the charge period and the charge time parameters, sends the command of connecting the charge loop of the leaf-acid battery to the measuring and controlling module within the set charge period and the charge time, and sends the command of disconnecting the loop of the lead-acid battery to the measuring and controlling module outside of the set charge period and the charge time.

5. The lead-acid battery system of claim 1, wherein both the first communication port of the measuring and controlling module and the third communication port of the gateway module are the RS485 interface.

6. The lead-acid battery system of claim 1, wherein the second communication port of the gateway module comprises at least one of the WIFI interface, GPRS interface, 3G interface and 4Ginterface.

7. The lead-acid battery system of claim 1, wherein the raw data storing unit is disposed in the housing of the lead-acid battery or the gateway module, the raw data stores the raw data at the time of shipment from the factory, and the raw data comprises the capacity and the charge and discharge characteristic curve of the various lead-acid batteries at the time of shipment from the factory.

8. The lead-acid battery system of claim 1, further comprising user terminal, the user terminal establishes communication with the second communication port of the gateway module, used to receive and store the status parameters and analytical results sent by the gateway module, used to send the command of connecting and disconnecting the charge and discharge loop of the lead-acid battery to the processor unit, and used to send the command of setting the status parameters threshold, charge period and charge time parameters to the processor unit.

9. The lead-acid battery system of claim 8, wherein the measuring and controlling module comprises a voltage acquisition unit, current acquisition unit and temperature acquisition unit respectively used to collect the voltage, current and internal temperature of the lead-acid battery; further comprises a servo unit used to connect and disconnect the charge and discharge loop of the lead-acid battery; the measuring and controlling module instantly connects the discharge loop of the lead-acid battery to supply power when AC is disconnected.

10. A lead-acid battery intelligent system, comprising:
the lead-acid battery system of claim 9;
a first lead-acid battery, the voltage acquisition unit, the current acquisition unit, the temperature acquisition unit, the servo unit and the first communication port of the lead-acid battery system are disposed in the first lead-acid battery; and
at least one second lead-acid battery, a voltage acquisition unit, a current acquisition unit, a temperature acquisition unit, a servo unit and a first communication port are disposed in the second lead-acid battery; the first lead-acid battery is connected in series to the second lead-acid battery.

11. A lead-acid battery control system, comprising:
a collecting unit and a servo unit, disposed in the housing of the lead-acid battery cell, the collecting unit is used to collect the status parameters of the lead-acid battery cell in use, the status parameters comprise voltage, current and internal temperature of the lead-acid battery cell; the servo unit is used to disconnect and connect the charge and discharge loop of the lead-acid battery cell;
an intelligent gateway, communicating with the collecting unit through the wired communication loop or wireless communication link, acquiring and uploading the status parameters of the lead-acid battery cell collected by the collecting unit at regular time; a raw data collecting unit, used to acquire the raw data of various lead-acid battery cells at the time of shipment from the factory; and
a cloud data managing and controlling platform, acquiring and storing the acquired raw data of various lead-acid battery cells at the time of shipment from the factory by the raw data collecting unit; the cloud data managing and controlling platform communicates with the intelligent gateway through wired or wireless communication link and receives the uploaded status parameters of the lead-acid battery cell by the intelligent gateway; the cloud data managing and controlling platform may drive the intelligent gateway to initiate the check of the discharge test of the lead-acid battery cell at regular time, to acquire the discharging curve and calculate the chargeability and health status of the various lead-acid battery cells by the discharging curve of the various lead-acid battery cells, raw data at the time of shipment from the factory and the acquired status parameters in real time, to locate and change the failed lead-acid battery cell.

12. The lead-acid battery control system of claim 11, when determining the acquired status parameters are abnormal, the intelligent gateway sends the command of disconnecting the charge loop of the lead-acid battery cell to the collecting unit, to control the servo unit disconnect the charge loop, and the abnormal status parameters comprise the voltage reaching to the set voltage threshold, the current reaching to the set current threshold and the internal temperature reaching to the set temperature threshold.

13. The lead-acid battery control system of claim 12, wherein the intelligent gateway sends the warning of the abnormal status parameters to the cloud managing and controlling platform to be dealt with by the users in time.

14. The lead-acid battery control system of claim 12, wherein the users can set the operation parameters in the intelligent gateway by the cloud data managing and controlling platform and the operation parameters comprise the voltage threshold, current threshold and the temperature threshold.

15. The lead-acid battery control system of claim 11, wherein the intelligent gateway communicates with the various collecting units in communicative connection therewith every n seconds to acquire the status parameters collected by the various collecting units; and the intelligent gateway broadcasts the time synchronizing command to the collecting unit in communicative connection therewith to guarantee that the intelligent gateway communicates with the various collecting units in communicative connection therewith every n seconds, wherein the n is the real number larger than 0.

16. The lead-acid battery control system of claim 11, when the communication is interrupted between the intelligent gateway and the cloud data managing and controlling platform, the intelligent gateway will store the status parameters acquired from the various collecting units and automatically upload again to the cloud data managing and controlling platform after the communication is restored.

17. The lead-acid battery control system of claim 11, wherein the intelligent gateway can communicate with the power supply via serial port or the network port; the intelligent gateway analyzes whether the charging parameters of the lead-acid battery cell by the power supply is reasonable or not according to the environmental temperature, status parameters and the raw data at the shipment from the factory of the lead-acid battery cell and performs the real-time adjustment and the charging parameters comprise equalized float charge voltage and the charge period.

18. The lead-acid battery control system of claim 11, wherein the raw data collecting unit groups the various lead-acid battery cells according to the acquired raw data at the time of the shipment for the factory of the various lead-acid battery cells.

19. The lead-acid battery control system of claim 11, wherein the raw data comprises the capacity of the lead-acid battery cell at the time of shipment from the factory and charge and discharge characteristic curve.

20. A lead-acid battery intelligent system, comprising:
the lead-acid battery control system of claim 11;
a first lead-acid battery cell, the collecting unit and servo unit of the lead-acid battery control system are disposed in the first lead-acid battery; and
at least one second lead-acid battery cell, the collecting unit of the lead-acid battery control system is disposed in the second lead-acid battery cell; the first lead-acid battery cell is connected in series to the second lead-acid battery cell.
